(19) United States
(12) Patent Application Publication
(10) Pub. No.: US 2014/0130622 A1
(43) Pub. Date: May 15, 2014

(54) BARRIER ASSEMBLY

(71) Applicants: Nicholas Michael Cassaday, Woodburn, IN (US); Craig Alan Newman, East Lansing, MI (US); David M. Gerst, Fort Wayne, IN (US); Walter John Budd, Rochester, MI (US); Richard Eugene Ridgway, Fort Wayne, IN (US)

(72) Inventors: Nicholas Michael Cassaday, Woodburn, IN (US); Craig Alan Newman, East Lansing, MI (US); David M. Gerst, Fort Wayne, IN (US); Walter John Budd, Rochester, MI (US); Richard Eugene Ridgway, Fort Wayne, IN (US)

(73) Assignee: International Truck Intellectual Property Company, LLC, Lisle, IL (US)

(21) Appl. No.: 14/131,332

(22) PCT Filed: Jul. 14, 2011
(86) PCT No.: PCT/US2011/043977

§ 371 Date: Jan. 7, 2014

(51) Int. Cl. F16H 59/02

(52) U.S. Cl. CPC F16H 59/0213
USPC 74/18

(57) ABSTRACT

A barrier assembly for a motor vehicle having a shift lever and a kit for assembling the barrier assembly are disclosed. The barrier assembly has a retainer, a lever plate, seals and spacers. The retainer has a retainer aperture extending from a first surface to a second surface. The lever plate is moveable and has a lever opening extending from a first face to a second face. A gliding surface allows the lever plate to move in a planar motion parallel to the retainer while supported on the retainer. A first seal is located on the first face of the lever plate proximal to the lever opening. A second seal is located on the first face of the lever plate distal to the lever opening. Spacers project from the retainer distal to the retainer aperture.

### BACKGROUND

Embodiments disclosed herein relate to a barrier assembly for a shift lever assembly used for a motor vehicle transmission.

The transmission of a motor vehicle transfers the engine's power to the vehicle's drive wheels. The transmission uses gears in particular gear ratios to start and move the vehicle. To select the correct gears, manually-shifted, mechanical transmissions are used, especially in the field of medium and heavy-duty vehicles. Typically, transmissions include a main section shifted directly or remotely by a manual shift lever.

The shifting mechanism includes a shift lever inserted through a hole in the floor of the vehicle. One end of the shift lever has a handle. The other end extends through a shift lever housing and plate and into the transmission, where it communicates with the gears that are shifted.

Such shifting mechanisms are often used on heavy duty trucks and other motor vehicles used for off-road applications. Construction sites and logging operations, for example, are often on badly rutted and rugged terrains without the benefit of paved or graded roads. Such vehicles must traverse the ruts, rocks and ridges often found and in all types of weather, without damaging their instruments and occupants from the force of vertical movement as well as dust, dirt and splash coming through openings in the vehicle.

### SUMMARY

A barrier assembly for a motor vehicle having a shift lever and a kit for assembling a barrier assembly are disclosed. The barrier assembly has a retainer, a lever plate, seals and spacers. The retainer has a first surface, an opposite second surface and a retainer aperture extending from the first surface to the second surface. The moveable lever plate has a first face, an opposite second face and a lever opening extending from the first face to the second face. A gliding surface allows the lever plate to move in a planar motion parallel to the retainer while supported by the retainer.

A first seal is located on the first face of the lever plate proximal to the lever opening. A second seal is located on the first face of the lever plate distal to the lever opening. Spacers project from the retainer distal to the retainer aperture toward the support.

### BRIEF DESCRIPTION OF THE DRAWINGS

FIG. 1 is a partial perspective view of a motor vehicle with a shift lever and barrier assembly;

FIG. 2 is a side view of a motor vehicle and a shift lever, with a barrier assembly and a transmission in phantom;

FIG. 3 perspective view of a shift lever assembly with an attached barrier assembly and a transmission in phantom;

FIG. 4 is a side view of a barrier assembly with part of the second seal and third seal removed;

FIG. 5 is a side view of a barrier assembly with part of the second seal removed;

FIG. 6 is a top plan view of a barrier assembly without a support;

FIG. 7 is a top plan view of a barrier assembly without a support;

FIG. 8 is a bottom plan view of a barrier assembly;

FIG. 9 is a bottom plan view of a barrier assembly;

FIG. 10 is a top plan view of a barrier assembly without a support;

FIG. 11 is a partial sectional view of a barrier assembly installed with a shift lever assembly;

FIG. 12 is a sectional view of a barrier assembly;

FIG. 13 is a sectional view of a barrier assembly after a shock is applied to the barrier assembly;

FIG. 14 is a partial sectional view of a barrier assembly and a shift lever assembly;

FIG. 15 is a partial sectional view of a barrier assembly and a shift lever assembly after a shock is applied to the barrier assembly;

FIG. 16 is a partial sectional view of a barrier assembly and a shift lever assembly; and

FIG. 17 is a partial sectional view of a barrier assembly and a shift lever assembly after a shock is applied to the barrier assembly.

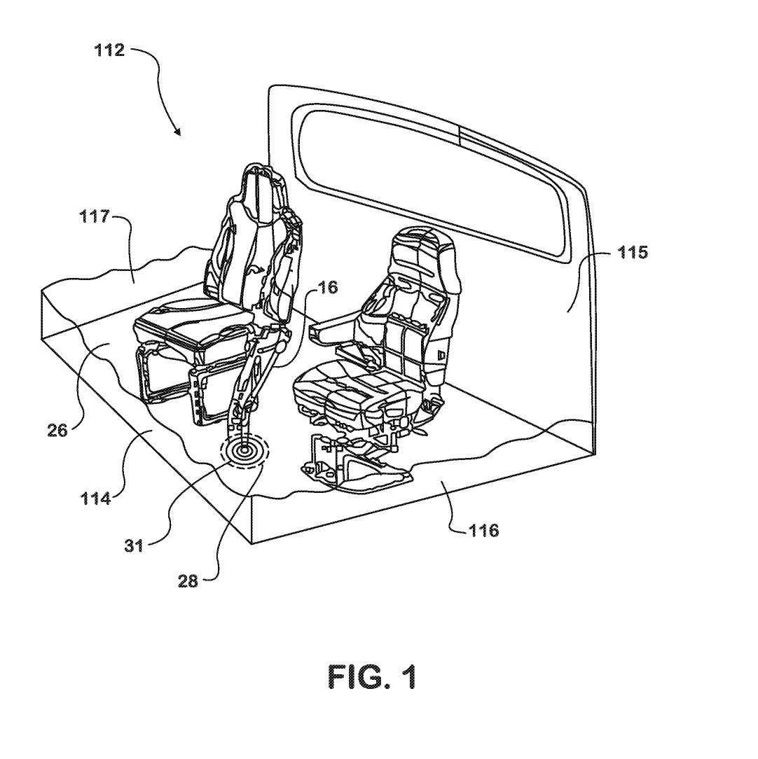

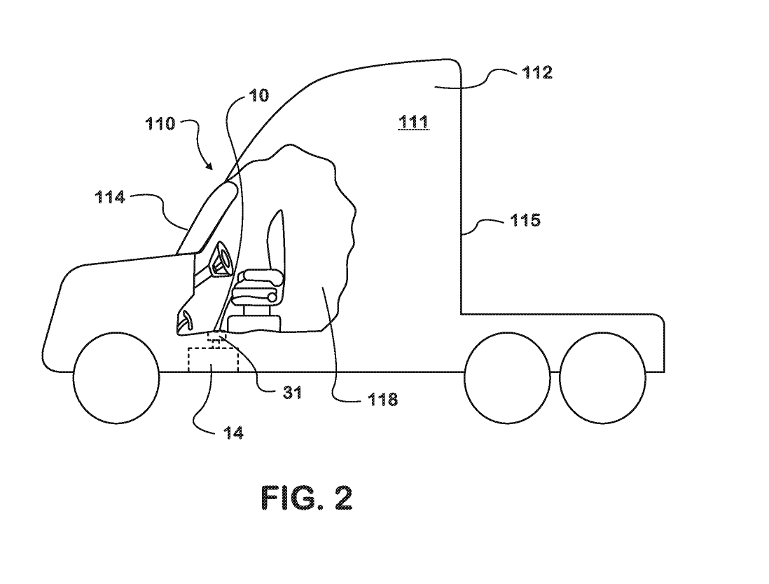

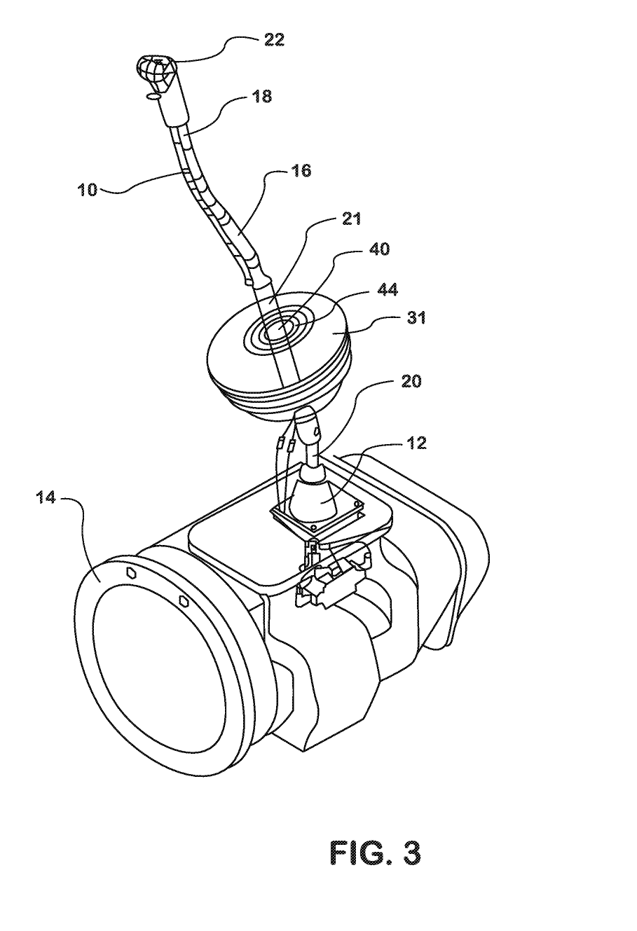

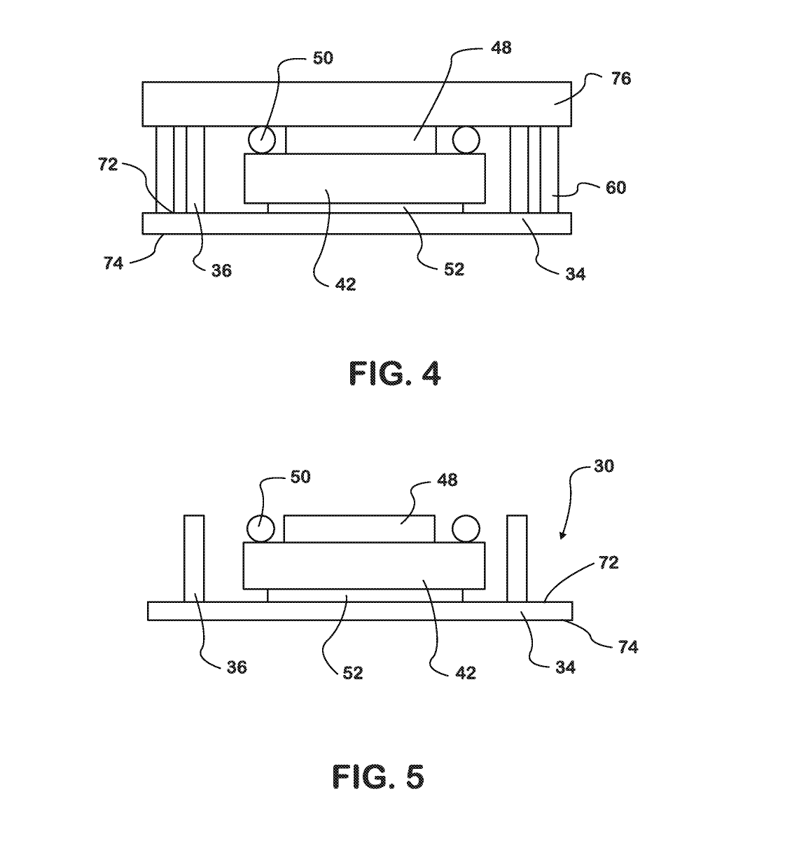

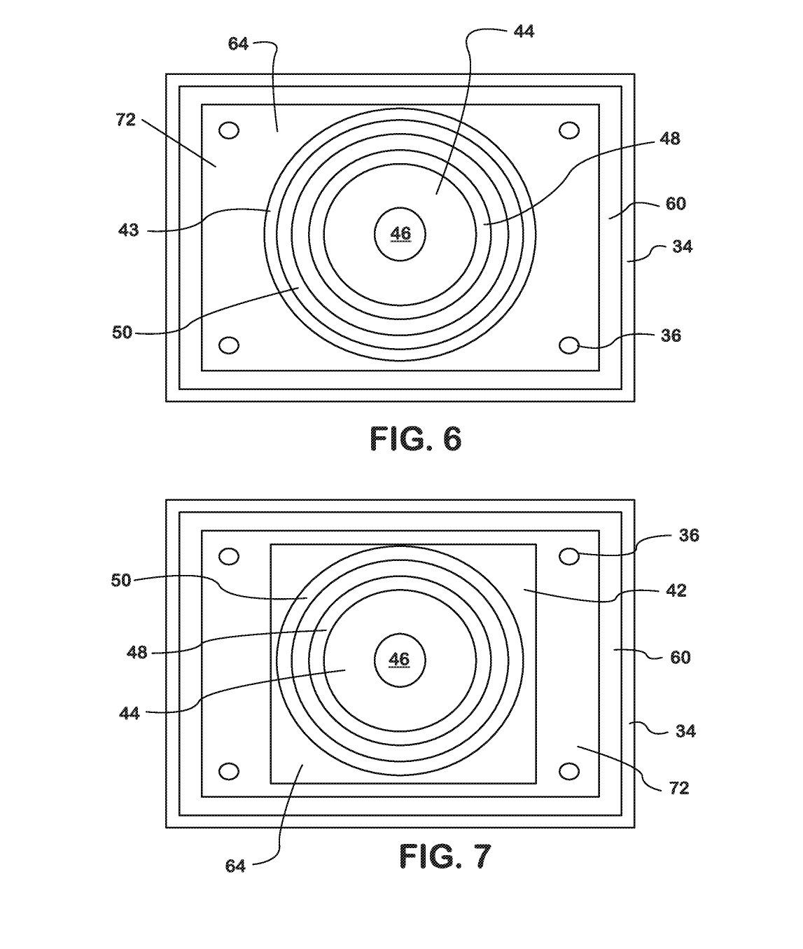

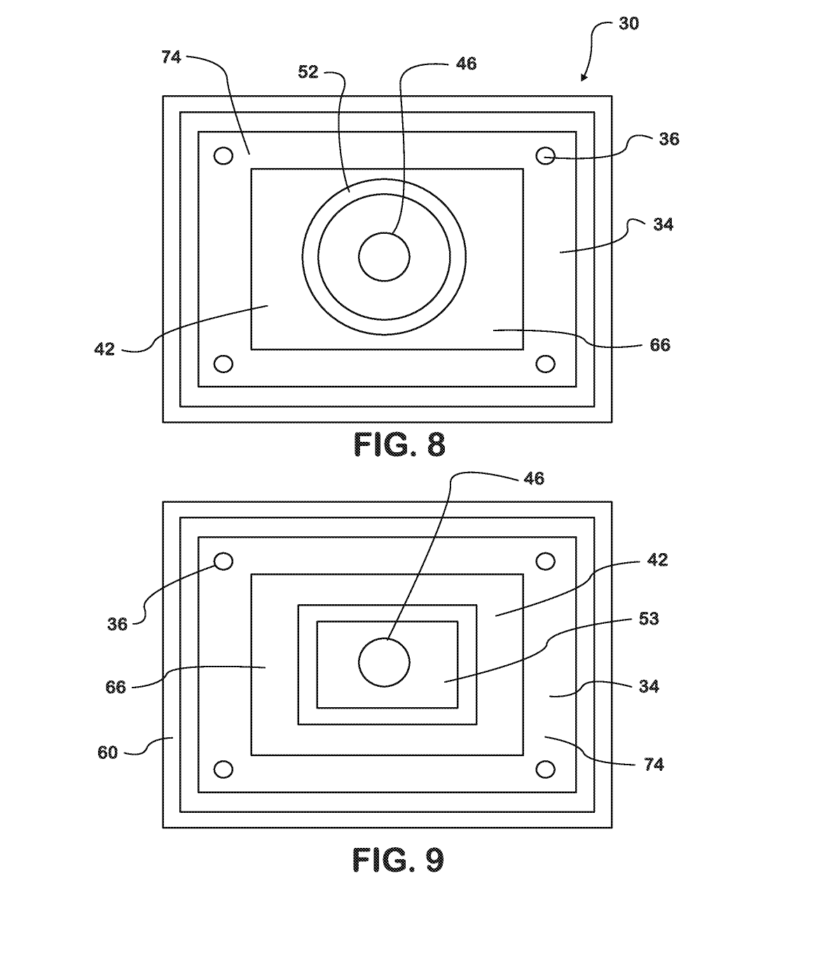

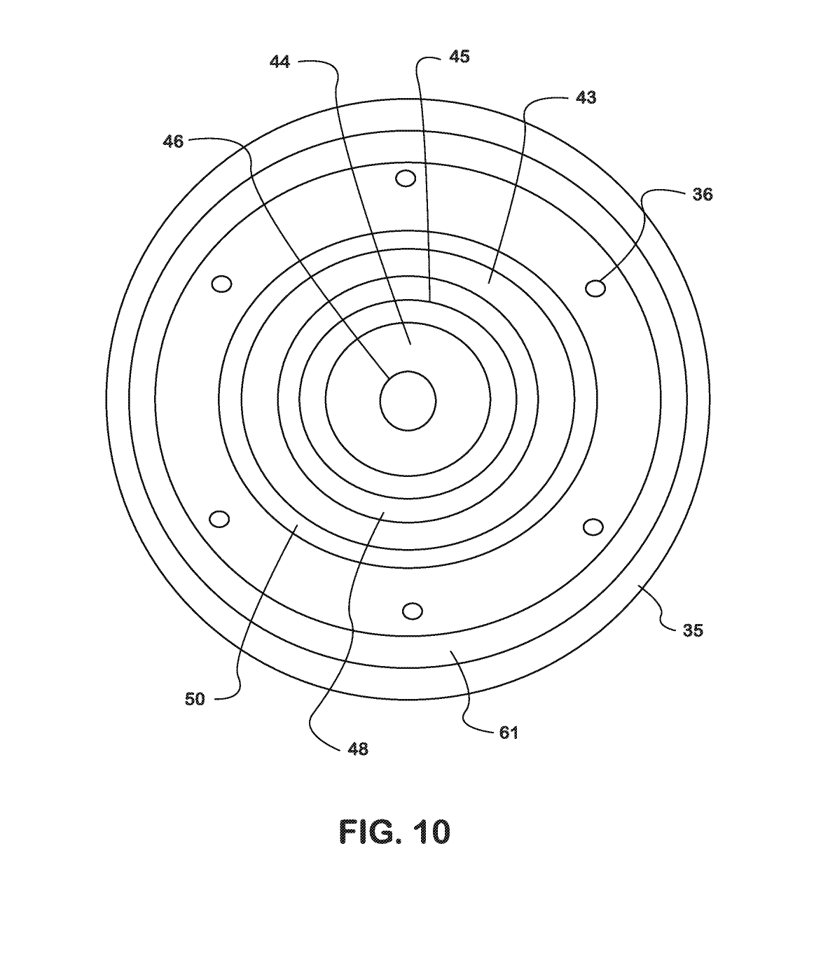

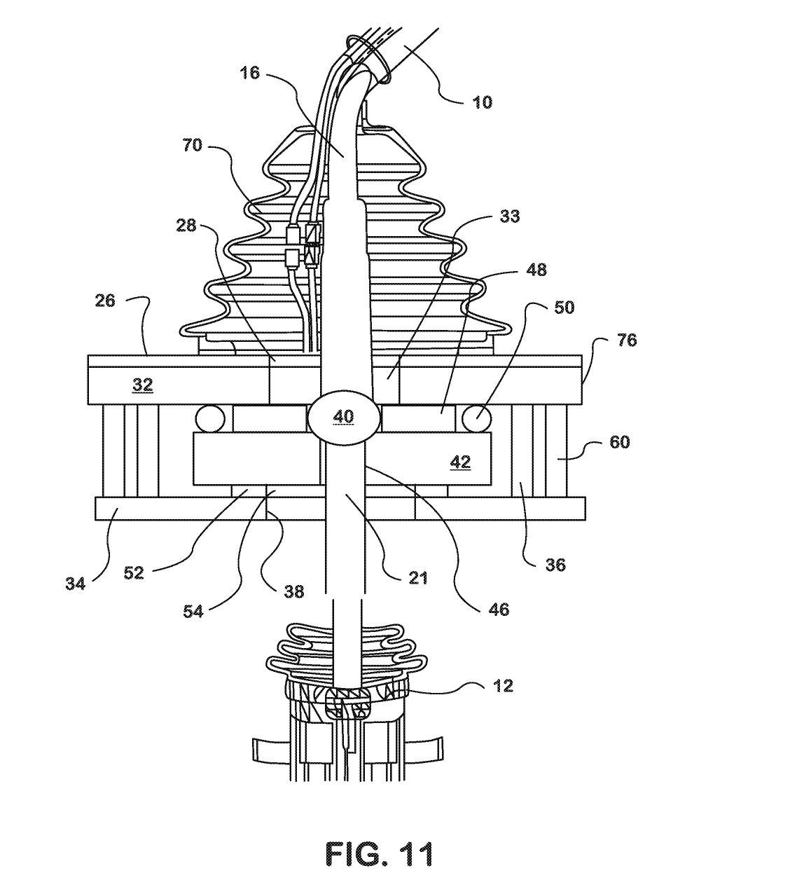

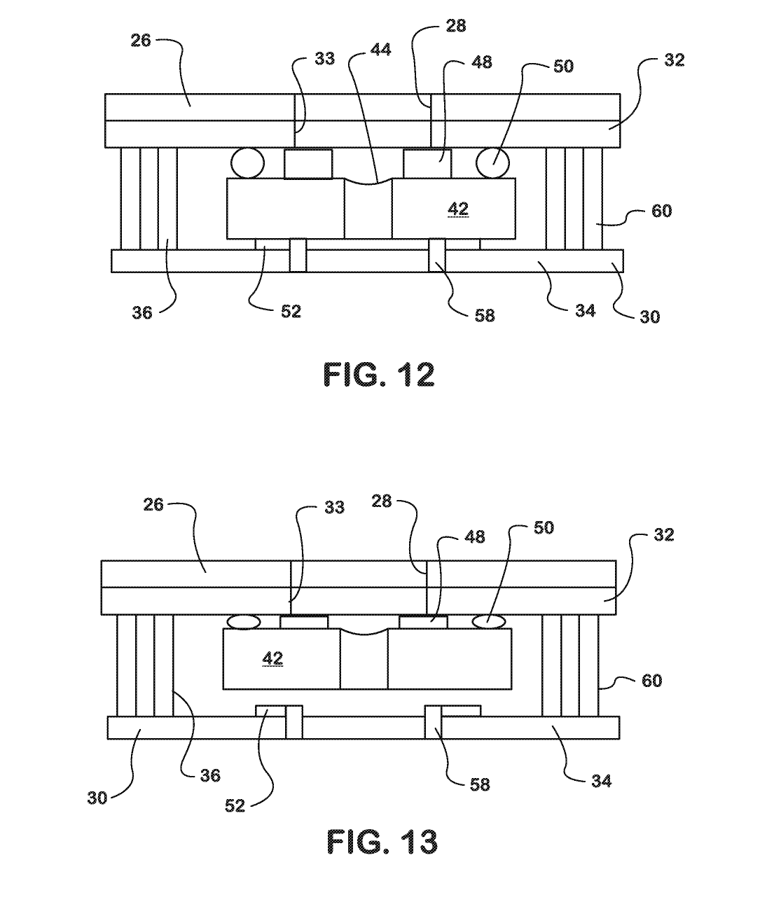

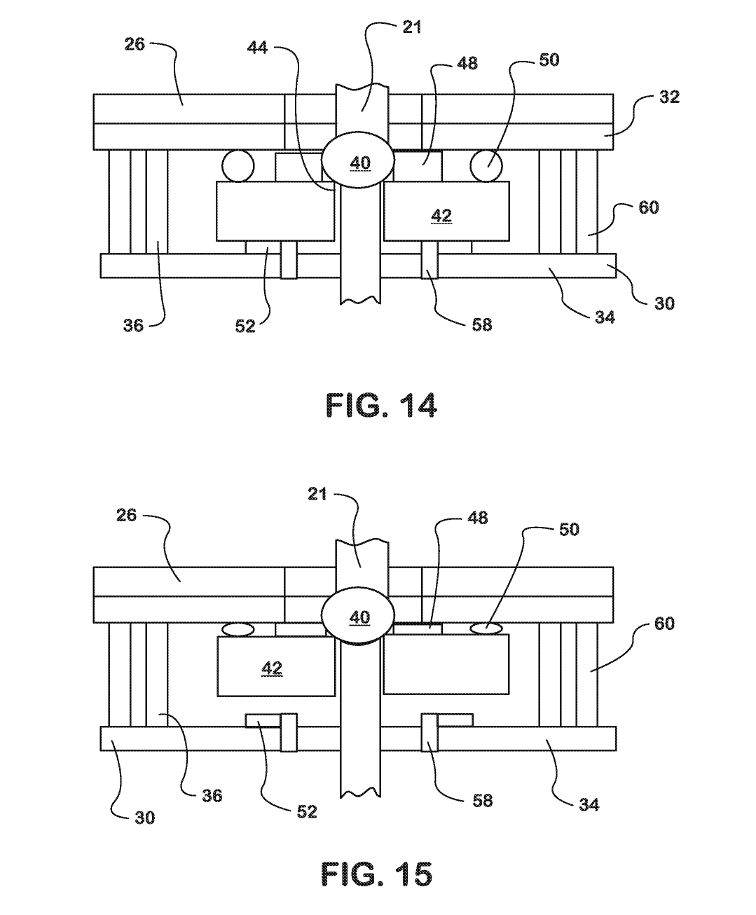

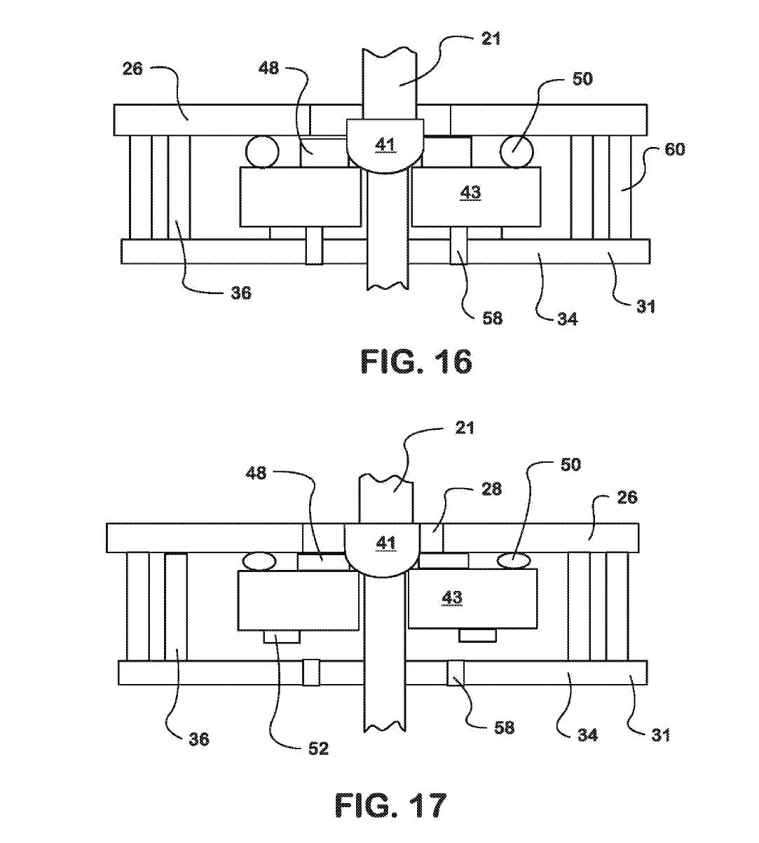

### DETAILED DESCRIPTION

Referring now to the Figures where like reference numerals refer to like structures, a motor vehicle 110 has a passenger compartment, such as a truck 111 with a cab 112 or a bus. Cab 112 has a cab front 114, a cab back 115 and cab sides 116, 117 therebetween to form a cab enclosure 118. A floor 26 is located at the bottom of the cab enclosure 118.

A shift lever assembly 10 is used to shift a motor vehicle's transmission 14 and is located near the cab front 114. The shift lever assembly 10 has a shift lever 16 with a first end 18, an opposite second end 20 and an intermediate section 21 therebetween. A handle 22 or knob is located at the first end 18 inside the cab enclosure 118. The shift lever 16 inserts through a floor hole 28 and into the transmission 14 beneath the vehicle's floor 26. The transmission 14 can have an attached shift lever housing 12 through which the shift lever 16 inserts before the second end 20 engages the gears of the transmission 14. The shift lever assembly 10 has an attached barrier assembly 30, 31.

The barrier assembly 30, 31 is located beneath the floor 26 at the floor hole 28. The barrier assembly 30, 31 has a retainer 34 and a moveable lever plate 42 engaging the shift lever 16. The retainer 34 and has a first surface 72, an opposite second surface 74 and a retainer aperture 38 extending from the first surface 72 to the second surface 74. The retainer aperture 38 is through which the shift lever 16 extends toward the transmission 14, and thus aligns with the floor hole 28. A support 76 can fasten to the retainer 34.

Spacers 36 maintain spacing between the retainer 34 and the support 76 by projecting from the retainer 34 distal to the retainer aperture 36 to the support 76. The spacers 36 can fasten the barrier assembly to the support 76.

The support 76 can be the floor 26 or a base 32 attaching to the floor 26. The base 32 has a base bore 33 aligning with the floor hole 28 and the retainer aperture 38.

The lever plate 42 has a first face 64, an opposite second face 66 and a lever opening 46 extending from the first face 64 to the second face 66. The lever plate 42 can have a socket 44 on the first face 64 that surrounds the lever opening 46. The lever plate 42 is larger than the floor hole 28 or the base bore 33. Part of the shift lever 16 extends through the lever opening 46 and engages the lever plate 42, 43.

The shift lever 16 has an attached shift bearing 40, 41. The shift bearing 40, 41 is adapted to engage the shift lever 16 and has at least one curved end 24, 25. The shift bearing 40 can be spherical or hemispherical and can be formed with a half sphere 41 or from two half spheres or a single sphere 40 with an opening in the center for accepting the shift lever 16. The curved end 24 of the shift bearing 40 at least partially engages the lever plate 42. The shift bearing 40 is larger than the lever opening 46 of the lever plate 42 and can have at least part of the curved end 24 matingly engaging the socket 44. The shift bearing 40, 41 can press fit to the lever plate 42, which can form the socket. The shift bearing 40 allows the shift lever 16 to move unrestricted in the plane of the lever plate 42.

A first seal 48 is located on the first face 64 of the lever plate 42 proximal to the lever opening 46. The first seal 48 engages the shift bearing 40 and can be located at the socket edge 45 or partially within the socket 44. A second seal 50 is located on the first face 64 of the lever plate 42 distal to the lever opening 46. At least one of the first seal 48 and the second seal 50 can engage the support 76. The first seal 48 and the second seal 50 can be resilient, allowing them to at least partially compress.

A third seal 60 can be located between the retainer 34 and the floor 26 or the base 32. A fourth seal 58 such as a brush seal or bushing can be located at least partially within the retainer aperture 38.

A gliding surface 56 allows the lever plate 42 to move in a planar motion in response to the movement of the shift lever 16 when shifting. The gliding surface 56 provides a low friction surface for the lever plate 42 to move smoothly on the retainer 34 in a planar motion parallel to the retainer 34. The gliding surface 56 can be at least part of the second face 66 of the lever plate 42 (not shown), at least part of a retainer second surface 74 of the retainer 34 (not shown) or part of a glider 52, 53 located between the retainer 34 and the lever plate 42. The glider 52 can have a glider bore 54 that aligns with at least part of the retainer aperture 38. The glider 52 can be a bearing attached to the retainer 34 or the lever plate 42.

The barrier assembly 30, 31 can be assembled from a kit of parts including the retainer, the lever plate and the first and second seals. The shift bearing can be part of the kit. During assembly from the kit of parts, the shift bearing 40 would attach to the shift lever 16 at the intermediate section 21 with the curved end 24 facing downward.

The first seal 48 and the second seal 50 engage the first face 64 of the lever plate 42. A glider 52 is attached to one of the retainer 34 or the lever plate 42, with the gliding surface 58 aligned to allow the lever plate 42 to move freely on the retainer 34. The glider bore 54 aligns with the retainer aperture 38.

The spacers 36 and any additional seals are used to engage the retainer 34 and the support 76. A fourth seal 58 can be used at least partially within the retainer aperture 38.

The shift lever 16 with attached shift bearing 40 would be placed through the floor hole 28 with the second end 20 engaging the transmission 14 beneath the retainer. The shift bearing 40 would be located below the floor 26. If a base 32 is used, the base bore 33 would be aligned with the floor hole 28 and the base 32 fastened to the floor 26 and the shift lever would go through the base bore.

The lever plate 42 engages the shift bearing 40 with the lower portion of the shift lever 16 extending through the lever opening 46, the glider bore 54 and retainer aperture 38. The retainer 34 attaches with fasteners to the floor 26, either directly or through the base 32. The second end 20 of the shift lever 16 inserts into the transmission 14 and any shift lever housing. The floor hole 28 can be covered with a boot 70, console or carpeting after assembly.

The assembled barrier assembly allows the lever plate to move in a planar direction when the shift lever is shifted to change gears in the transmission. The shift lever, however, is not allowed to move vertically during shifting and normal driving conditions.

If the motor vehicle receives a large shock or experiences vertical movement, however, the lever plate moves vertically with the shift lever. The first seal and the second seal can compress against the support and prevent the shift lever from moving further upward, while keeping the floor hole sealed from the outside. The spacers maintain the separation between the retainer and the support.

What is claimed is:

1. A barrier assembly for a motor vehicle having a shift lever, comprising:
a retainer having a first surface, an opposite second surface, and a retainer aperture extending from the first surface to the second surface;
a moveable lever plate having a first face, an opposite second face, and a lever opening extending from the first face to the second face;
a gliding surface for allowing the lever plate to move in a planar motion parallel to the retainer while supported on the retainer;
a first seal being located on the first face of the lever plate proximal to the lever opening;
a second seal being located on the first face of the lever plate distal to the lever opening; and
spacers projecting from the retainer distal to the retainer aperture.

2. The barrier assembly for a motor vehicle having a shift lever of claim 1, wherein the gliding surface further comprises:
a glider being located between the retainer and the lever plate and having a glider bore aligning with at least part of the retainer aperture.

3. The barrier assembly for a motor vehicle having a shift lever of claim 2, wherein the lever plate further comprises:
a socket on the first face of the lever plate surrounding the lever opening.

4. The barrier assembly for a motor vehicle having a shift lever of claim 2, further comprising:
a support fastening to the retainer and engaging the second seal and the spacers; and
a third seal located between the retainer and the support.

5. The barrier assembly for a motor vehicle having a shift lever of claim 4, wherein the glider is attached to the retainer, and the gliding surface faces the second face of the lever plate.

6. The barrier assembly for a motor vehicle having a shift lever of claim 5, wherein the support is a base having a base bore, and the base engages the spacers distal to the base bore.

7. The barrier assembly for a motor vehicle having a shift lever of claim 6, further comprising:
a shift bearing attaching the shift lever; and
a curved end of the shift bearing at least partially engaging the lever plate.

8. A barrier assembly for a motor vehicle having a transmission, a floor, a floor hole, and a shift lever extending through the floor hole to the transmission, comprising:
a retainer having a first surface, an opposite second surface, and a retainer aperture extending from the first surface to the second surface and through which part of the shift lever extends;
a moveable lever plate having a first face, an opposite second face, and a lever opening extending from the first face to the second face and through which part of the shift lever extends;
a gliding surface for allowing the lever plate to move in a planar motion parallel to the retainer in response to the movement of the shift lever when shifting;
a first seal being located on the first face of the lever plate proximal to the lever opening;
a second seal being located on the first face of the lever plate distal to the lever opening; and
spacers projecting from the retainer toward the floor.

9. The barrier assembly for a motor vehicle of claim 8, wherein the gliding surface further comprises:
a glider being located between the retainer and the lever plate and having a glider bore aligning with at least part of the retainer aperture.

10. The barrier assembly for a motor vehicle of claim 9, wherein the lever plate further comprises:
a socket on the first face of the lever plate surrounding the lever opening.

11. The barrier assembly for a motor vehicle of claim 9, further comprising:
a support fastening to the retainer and engaging the second seal and the spacers; and
a third seal located between the retainer and the support.

12. The barrier assembly for a motor vehicle of claim 11, wherein the glider is attached to the retainer, and the gliding surface faces the second face of the lever plate.

13. The barrier assembly for a motor vehicle of claim 12, wherein the support is a base having a base bore, and the base engages the spacers distal to the base bore.

14. The barrier assembly for a motor vehicle of claim 12, further comprising:
a shift bearing attaching the shift lever; and
a curved end of the shift bearing at least partially engaging the lever plate.

15. The barrier assembly for a motor vehicle of claim 14, wherein the retainer and the lever plate are located between the transmission and the floor, and the retainer is fastened to the floor.
